(19) United States
(12) Patent Application Publication
(10) Pub. No.: US 2014/0020626 A1
(43) Pub. Date: Jan. 23, 2014

(54) FILM CRACK DETECTING APPARATUS AND FILM FORMING APPARATUS

(71) Applicant: TOKYO ELECTRON LIMITED, Tokyo (JP)

(72) Inventors: Yudo SUGAWARA, Iwate (JP); Kazuhide HASEBE, Yamanashi (JP)

(73) Assignee: TOKYO ELECTRON LIMITED, Tokyo (JP)

(21) Appl. No.: 13/943,981

(22) Filed: Jul. 17, 2013

(30) Foreign Application Priority Data
Jul. 19, 2012 (JP) 2012-160574

(51) Int. Cl. G01N 29/14

(52) U.S. Cl. CPC G01N 29/14
USPC 118/712; 73/587

(57) ABSTRACT

Provided is a film crack detecting apparatus capable of recognizing a possibility of occurrence of particles in real time by detecting film cracks of an unnecessary film adhered to a probe unit provided in a processing container. The film crack detecting apparatus is provided in a film forming apparatus, which includes a processing container configured to accommodate an object to be processed and forms a thin film on a surface of the object, to perform a film crack detection operation. The film crack detecting apparatus includes a probe unit installed within the processing container, an elastic wave detecting unit attached to an end of the probe unit to detect an elastic wave, and a determination unit configured to determine whether the maintenance of the processing container is necessary based on a detection result of the elastic wave detecting unit.

### CROSS-REFERENCE TO RELATED APPLICATIONS

This application is based on and claims priority from Japanese Patent Application No. 2012-160574 filed on Jul. 19, 2012 with the Japan Patent Office and the disclosure of which is incorporated herein in its entirety by reference.

### TECHNICAL FIELD

The present disclosure relates to a film forming apparatus for forming a thin film on, for example, a semiconductor wafer and a film crack detecting apparatus attached to the film forming apparatus.

### BACKGROUND

In general, in order to manufacture a semiconductor device such as a semiconductor integrated circuit, various processings such as, for example, a film forming processing, an etching processing, an oxidation processing, and a diffusion processing are repeatedly performed in relation to a semiconductor wafer such as, for example, a silicon substrate. For example, a batch-type film forming process is adapted to form a thin film by accommodating a plurality of semiconductor wafers supported by a wafer boat in an oblong quartz processing container, and introducing a film forming gas into the processing container while heating the plurality of semiconductor wafers to a predetermined temperature under a vacuum atmosphere. See, e.g., Japanese Patent Laid Open Publication Hei 06-275608.

When the film forming processings are repeatedly performed as described above, an unnecessary film may also be gradually adhered and deposited to, for example, an inner surface of the processing container. When the unnecessary film is peeled off and drops, particles occur which become the cause of reducing product yield. For this reason, in the past, for example, the unnecessary film was removed prior to the occurrence of peeling-off of the unnecessary film by managing an accumulation value of thicknesses of films formed on wafers and performing a maintenance processing such as, for example, a cleaning processing, regularly or irregularly prior to the occurrence of peeling-off.

### SUMMARY

According to a first viewpoint of the present disclosure, there is provided a film crack detecting apparatus provided in a film forming apparatus, which includes a processing container configured to accommodate an object to be processed and forms a thin film on a surface of the object, so as to perform a film crack detection operation. The film crack detecting apparatus includes a probe unit provided within the processing container, an elastic wave detecting unit attached to an end of the probe unit and configured to detect an elastic wave, and a determination unit configured to determine whether a maintenance of the processing container is necessary based on a detection result of the elastic wave detecting unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a longitudinal cross-sectional view illustrating a configuration of a film forming apparatus to which a film crack detecting apparatus according to the present disclosure is attached.

FIG. 2 is a partially enlarged cross-sectional view illustrating an attached state of the film crack detecting apparatus.

FIG. 3 is a block diagram illustrating a configuration of a determination unit of the film crack detecting apparatus.

FIG. 4 is a view illustrating a portion of a first modified embodiment of the film crack detecting apparatus of the present disclosure.

FIGS. 5A and 5B are graphs illustrating the relationship between the loads and occurring film cracks.

FIGS. 6A and 6B are views illustrating waveforms at a point where the intensity of elastic waves was the largest.

FIG. 7 is a block diagram illustrating a portion of a second modified embodiment of the film crack detecting apparatus of the present disclosure.

FIGS. 8A to 8C are graphs for analyzing the occurrence of micro-cracks obtained based on the data obtained in FIGS. 5A and 5B.

FIGS. 9A to 9D are graphs illustrating the relationships of the AE original form waves and frequency distributions of the groups, respectively.

FIG. 10 is a block diagram illustrating a portion of a third modified embodiment of the film crack detecting apparatus of the present disclosure.

FIG. 11 is a schematic view illustrating a principal portion of a fourth modified embodiment of the film crack detecting apparatus of the present disclosure.

FIG. 12 is a block diagram illustrating the configuration of a fourth modified embodiment.

FIG. 13 is a diagram for describing the principle of specifying a film crack occurrence position.

FIG. 14 is a schematic view illustrating a principal portion of a fifth modified embodiment of the film crack detecting apparatus of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

In the maintenance processing of the related art as described above, when an estimated accumulation value of film thicknesses for starting a maintenance processing such as a cleaning processing is too large, the maintenance processing is excessively delayed. As a result, there is a problem in that a substantial yield reduction may be caused due to a large amount of occurring particles. On the contrary, when the estimated accumulation value of film thicknesses is too small, the cleaning processing may be performed even though the amount of occurring particles is substantially smaller than a permissible amount, and thus, the cleaning frequency may increase. As a result, there is a problem in that the throughput may be reduced or the wear damage of the processing container may be accelerated.

The present disclosure has been made in an effort to solve the problems as described above. The present disclosure provides a film crack detecting apparatus and a film forming apparatus in which the possibility of occurrence of particles may be recognized in real time by detecting film cracks of an unnecessary film adhered to a probe unit provided within a processing chamber.

Through a careful research for film cracks of an unnecessary film which become the cause of occurrence of particles, it has been found out that when a film crack occurs, a small elastic wave occurs and thus, the occurrence of a film crack may be recognized by detecting the elastic wave. The present disclosure has been made from this finding.

According to a first viewpoint of the present disclosure, there is provided the film crack detecting apparatus provided in a film forming apparatus, which includes a processing container configured to accommodate an object to be processed and forms a thin film on a surface of the object, so as to perform a film crack detection operation. The film crack detecting apparatus includes a probe unit provided within the processing container, an elastic wave detecting unit attached to an end of the probe unit and configured to detect an elastic wave, and a determination unit configured to determine whether a maintenance of the processing container is necessary based on a detection result of the elastic wave detecting unit.

In the film crack detecting apparatus, the probe unit may be provided along a height direction of the processing container. In addition, the probe unit may include a probe body which is provided with a vertical probe portion having a lower end fixed to a lower end of the processing container and extending along a height direction of the processing container.

In the film crack detecting apparatus, the probe body may be provided with two vertical probe portions each having a lower end fixed to a lower end of the processing container and extending upwardly along the height direction of the processing container in parallel to each other. The vertical probe portions are connected with each other at top ends thereof.

In the film crack detecting apparatus, the elastic wave detecting unit may be provided at each end side of the vertical probe portions. Further, the film crack detecting apparatus may further include a film crack position specifying unit configured to specify a film crack occurrence position based on a detection result of the elastic wave detecting unit.

In the film crack detecting apparatus, the probe body may include: two vertical probe portions each having a lower end fixed to a lower end of the processing container and extending upwardly along the height direction of the processing container in parallel to each other, and a ring-shaped horizontal probe portion extending substantially all around the processing container in the circumferential direction of the processing container and formed by connecting top ends of the two vertical probe portion. In the film crack detecting apparatus, a plurality of probe units may be provided and the ring-shaped horizontal probe portions of the probe units may be disposed at different height positions.

In the film crack detecting apparatus, the elastic wave detecting unit may be provided at each end side of the vertical probe portions. In addition, the film crack detecting apparatus may further include a film crack position specifying unit configured to specify a film crack occurrence position based on a result of the elastic wave detecting unit.

In the film crack detecting apparatus, the probe unit may be formed in a hollow rod shape or a solid rod shape. In addition, the probe unit may be formed of a material which is the same as that of the processing container.

In the film crack detecting apparatus, the processing container may be formed in a double tube structure of an inner cylinder and an outer cylinder and the probe unit may be positioned inside of the inner cylinder.

In the film crack detecting apparatus, the elastic wave detecting unit may output a plurality of signals. The film crack detecting apparatus may further include an intensity filter unit configured to output a signal having an intensity of a predetermined level or more among the signals output from the elastic wave detecting unit as an elastic wave detection signal.

The film crack detecting apparatus may further include a first frequency filter unit configured to allow a signal of a predetermined frequency range among the signals output from the intensity filter unit to pass through the first frequency filter.

In the film crack detecting apparatus, the determination unit may include: a count unit configured to calculate the number of times of detecting elastic wave detection signals, and a comparison unit configured to compare the output of the count unit with a reference value set in advance.

In the film crack detecting apparatus, the count unit may calculate an accumulation value after a most recent maintenance processing has been performed for the processing container. In addition, the count unit may calculate an accumulation value of every unit time which is intermittently measured. Further, the count unit calculates the number of times of detecting the elastic wave detection signal at every unit time. Moreover, the count unit may calculate the number of times detecting the elastic wave detection signal and may calculate an increase tendency of the number of detection times at every unit time.

In the film crack detecting apparatus, the determination unit may include a second frequency filter unit configured to determine whether the output of the intensity filter unit has a signal of a predetermined frequency range.

In the film crack detecting apparatus, a film crack detection operation may be performed during the warming of the processing container, during the cooling of the processing container, and during the forming of the thin film.

The film crack detecting apparatus may further include a display unit configured to display a determination result of the determination unit.

In the film crack detecting apparatus, the elastic wave detecting unit may be provided with a cooling mechanism configured to cool the elastic wave detecting unit.

In the film crack detecting apparatus, a wave guide rod member may be interposed between the probe unit and the elastic wave detecting unit.

In the film crack detecting apparatus, the wave guide rod member may be formed with a heat-dissipation fin.

As described above, since the film crack detecting apparatus provided in a film forming apparatus, which includes a processing container configured to accommodate an object to be processed and forms a thin film on a surface of the object, so as to perform a film crack detection operation is configured to include a probe unit provided within the processing container, an elastic wave detecting unit attached to an end of the probe unit and configured to detect an elastic wave, and a determination unit configured to determine whether a maintenance of the processing container is necessary based on a detection result of the elastic wave detecting unit, the possibility of occurrence of particles may be recognized in real time by estimating film cracks of an unnecessary film adhered to, for example, an inner wall of the processing container by detecting film cracks occurring in a thin film adhered to the surface of the probe unit.

According to a second view point of the present disclosure, there is provided a film forming apparatus including: a processing container configured to accommodate an object to be processed, a holding unit configured to hold the object, a heating unit configured to heat the object, a gas supply unit configured to supply a gas into the processing container so that a thin film is formed on a surface of the object, an exhaust system configured to exhaust the atmosphere within the processing container, a film crack detecting apparatus as described above, and an apparatus control unit configured to an operation of the entire film forming apparatus.

The film crack detecting apparatus and the film forming apparatus according to the present disclosure may exhibit excellent acting effects as follows.

Since the film crack detecting apparatus provided in a film forming apparatus, which includes a processing container configured to accommodate an object to be processed and forms a thin film on a surface of the object, so as to perform a film crack detection operation is configured to include a probe unit provided within the processing container, an elastic wave detecting unit attached to an end of the probe unit and configured to detect an elastic wave, and a determination unit configured to determine whether a maintenance of the processing container is necessary based on a detection result of the elastic wave detecting unit, the possibility of occurrence of particles may be recognized in real time by estimating film cracks of an unnecessary film adhered to, for example, an inner wall of the processing container by detecting film cracks occurring in a thin film adhered to the surface of the probe unit. Thus, a maintenance processing such as a cleaning processing may be properly performed in a timely manner.

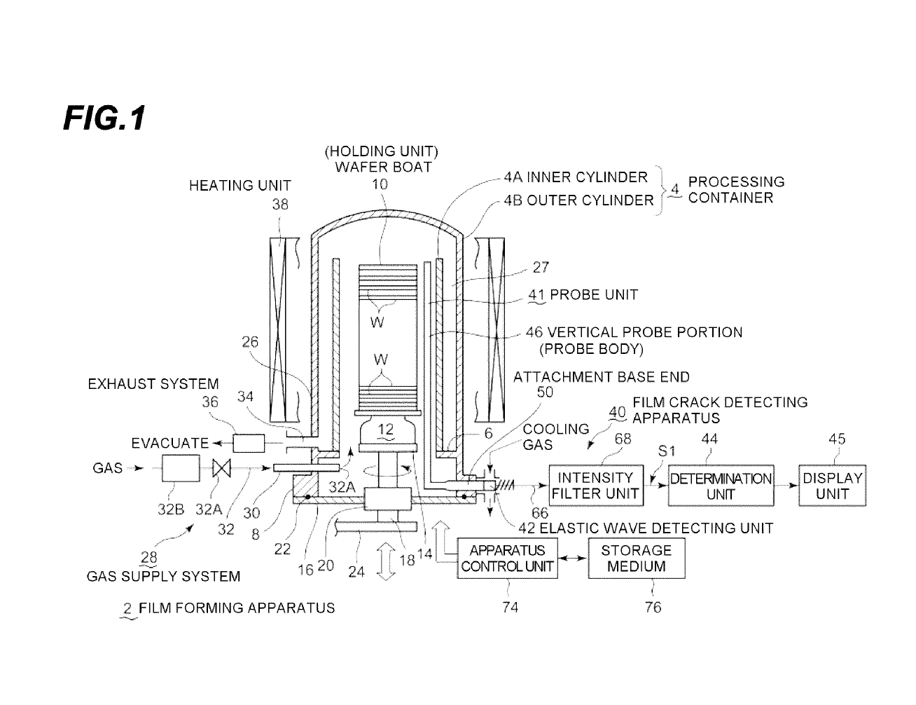

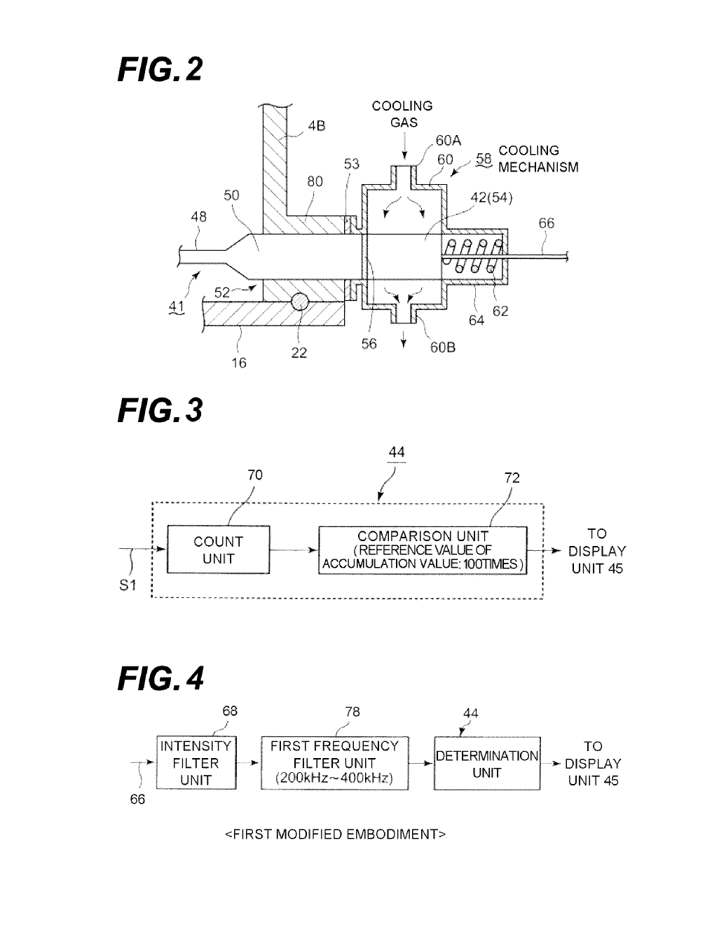

Hereinafter, an exemplary embodiment of a film crack detecting apparatus and a film forming apparatus according to the present disclosure will be described with reference to accompanying drawings. FIG. 1 is a longitudinal cross-sectional view illustrating a configuration of an example of a film forming apparatus to which a film crack detecting apparatus according to the present disclosure is attached, FIG. 2 is a partial enlarged cross-sectional view illustrating the attached state of the film crack detecting apparatus, and FIG. 3 is a block diagram illustrating a configuration of a determination unit in the film crack detecting apparatus.

As illustrated, the film forming apparatus 2 includes a processing container 4 of a cylindrical shape opened at the lower end thereof and having a ceiling. The entire processing container 4 is formed of, for example, quartz. The processing container 4 is formed by an inner cylinder 4A formed in a cylindrical shape and an outer cylinder 4B arranged outside of the inner cylinder 4A coaxial to the inner cylinder 4A and having a ceiling. A gap is formed between the inner cylinder 4A and the outer cylinder 4B. The inner cylinder 4A is supported by a support ring 6 formed in a ring shape at the lower part of the inside wall of the outer cylinder 4B. In addition, the lower end of the processing container 4, i.e. the lower end of the outer cylinder 4B is opened. A thick flange portion 8 is formed in a ring shape at the lower end. The opening of the lower end may be configured such that a cylindrical manifold formed of, for example, a stainless steel may be connected thereto.

In the opening of the lower end of the processing container 4, a quartz wafer boat 10 as a holding means, in which a plurality of semiconductor wafers W as objects to be processed are arranged in multi-stages, may be lifted up and down and introduced into or removed from the opening at the underside thereof. In the present exemplary embodiment, for example, about 50 to 150 wafers W, the diameter of which is 300 mm, may be supported in multi-stages substantially at an equal pitch by a support pole (not illustrated) of the wafer boat 10.

The wafer boat 10 is disposed on a table 14 via a heat insulating tube 12 formed of quartz and the table 14 is supported on a rotating shaft 18 which penetrates a closure 16. The closure 16 is configured to open/close the opening of the lower end of the processing container 4 and formed of, for example, stainless steel. In addition, for example, a magnetic fluid seal 20 is interposed between the rotating shaft 18 and the penetration portion to hermetically seal and rotatably support the rotating shaft 18. Further, a seal member 22 made of, for example, an O-ring, is interposed between the peripheral area of the closure16 and the lower end of the processing container 4 so as to maintain the sealing of the interior of processing container 4.

The rotating shaft 18 is attached to the front end of an arm 24 supported by an elevating mechanism such as, for example, a boat elevator (not illustrated), and configured to elevate the wafer boat 10 and the closure16 in unison such that the wafer boat 10 and the closure16 may be introduced into or removed from the interior of the processing container 4. Meanwhile, the table 14 may be fixedly provided at the closure16 side so that the wafers W may be processed without rotating the wafer boat 10.

A gas supply system 28 is provided at the lower side wall 26 of the processing container 4 so as to supply a required gas such as a film-forming gas to the interior or the processing container 4. Specifically, the gas supply system 28 includes a gas nozzle 30 made of a quartz tube which penetrates the lower side wall 26 of the processing container 4 inwardly. The gas nozzle 30 is configured such that a gas may be injected from a gas injection hole 30A of the front end of the gas nozzle 30. A gas passage 32 is connected to the gas nozzle 30. In addition, the gas passage 32 is provided with an opening/closing valve 32A and a flow rate controller 32B such as a mass flow controller so that the gas may be supplied in a flow-controlled manner.

FIG. 1 illustrates only one gas supply system 28. However, in practice, a plurality of gas supply systems having the same configuration may be provided, for example, by the number of kinds of gases to be used. When a silicon nitride film is formed, gases such as, for example, dichlorosilane which is a silane-based gas, ammonia which is a nitriding gas, and nitrogen gas which is a purge gas, are used.

In addition, an exhaust port 34 is formed in the lower side wall 26 of the processing container 4 at a position corresponding to that of the gap 27 between the inner cylinder 4A and the outer cylinder 4B. An exhaust system 36 is connected to the exhaust port 34 via, for example, a pressure regulating valve or a vacuum pump (not illustrated) so that the atmosphere within the processing container 4 may be evacuated and maintained at a predetermined pressure. Accordingly, the gas introduced from the gas nozzle 30 flows such that it ascends within the inner cylinder 4A, turns back at the ceiling portion, and descends within the gap 27 between the inner cylinder 4A and the outer cylinder 4B to be discharged from the exhaust port 34.

Further, a cylindrical heating unit 38 is provided to enclose the outside of the processing container 4, in which the cylindrical heating unit 38 is configured to heat the processing container 4 and the wafers W within the processing container 4. In addition, the processing container 4 is provided with a film crack detecting apparatus 40 according to the present disclosure. The film crack detecting apparatus 40 includes: a probe unit 41 provided in the processing container 4; an elastic wave detecting unit 42 attached to an end of the probe unit 41 to detect an elastic wave; and a determination unit 44 configured to determine whether a maintenance processing of the processing container 4 is needed based on a detection result of the elastic wave detecting unit 42. Further, the determination unit 44 is connected with a display unit 45 which is configured to display the determination result by the determination unit 44.

Specifically, the probe unit 41 is provided in the processing container 4 along the height direction of the processing container 4. The probe unit 41 is provided with a probe body 48 which includes a vertical probe portion 46 having a lower end fixed to the lower end of the processing container 4 and extending along the height direction of the processing container 4. The lower end of the probe body 48 is bent substantially at a right angle and the diameter of the lower end is expanded to form a cylindrical attachment base end 50.

The cylindrical attachment base end 50 has a predetermined length and is inserted through an attachment hole 52 formed in the flange 8. The front end of the cylindrical attachment base end 50 is fixed in a state where it slightly extends to the outside of the processing container 4. At the attachment portion of the attachment base end 50, a seal member 53 is provided to secure the sealing of the portion. Here, the probe body 48 is disposed inside of the inner cylinder 4A, i.e. in the gap portion between the inner cylinder 4A and the wafer boat 10, and the top end of the probe body 48 is set to a length arriving at the uppermost stage of the wafer boat 10 so that the probe body 48 may cover the entire wafer accommodating area.

The entire probe unit 41, i.e. the probe body 48 having the vertical probe portion 46 and the attachment base end 50 is formed of a material which is the same as the material of the processing container 4, in particular, the material of the inner cylinder 4A, and the surface of the probe body 48 is configured to allow an unnecessary film to be attached thereto with the same behavior as that on the inner surface of the inner cylinder 4A. Here, the inner cylinder 4A and the probe unit 41 are formed of, for example, heat-resistant quartz. The probe body 48 is formed in a pipe-like hollow rod shape or a solid rod shape which has a diameter of, for example, about 10 mm. Moreover, the cross-sectional shape of the probe body 48 may be formed in a rod shape of which the cross-section has a circular arc shape with a curvature which is the same as that of the inner cylinder 4A. In addition, when the probe body 48 is the pipe-like hollow rod shape, the intensity of the probe body 48 may be increased against the stress in relation to the thin film adhered to the outer circumferential surface thereof.

The probe body 48 may be partially supported by the inner cylinder 4A side. Alternatively, when a diffusion nozzle accommodation recess is formed in the inner cylinder 4A, the probe body 48 may be attached by being accommodated in the accommodation recess.

The elastic wave detecting unit 42 is attached to the end surface of the attachment base end 50 of the probe unit 41. Here, the elastic wave refers to a wave which is generated when a material releases deformation energy accumulated therein when the material is deformed or cracked. As for the elastic wave detecting unit 42, an acoustic emission (“AE”) sensor 54 may be used. In addition, a contact medium 56 which facilitates the transfer of the elastic wave is interposed in the interface of the end surface of the attachment base end 50 and the AE sensor 54. As for the contact medium 56, for example, water glass, silicon glass, or a metal plate formed from a soft metal such as a copper plate or a gold plate may be used.

The AE sensor 54 may incorporate a piezoelectric element such as, for example, PZT (lead zirconate titanate) and has a frequency range from few kHz to several tens of kHz as a vibration frequency range. As for the AE sensor 54, such as, for example, VS150-M (manufactured by Vallen Systeme GmbH) may be used.

In addition, the elastic wave detecting unit 42 is provided with a cooling mechanism 58 so as to cool the elastic wave detecting unit 42. The cooling mechanism 58 includes a cooling casing 60 provided to enclose the surrounding of the elastic wave detecting unit 42. In addition, a cooling medium inlet 60A and a cooling medium outlet 60B are provided in the cooling casing 60 so that a cooling medium flows in the cooling casing 60 to cool the elastic wave detecting unit 42. By cooling the elastic wave detecting unit 42 in this manner, it is possible to suppress the elastic wave detecting unit 42 from being damaged by heat. Here, as for the cooling medium, a cooling gas such as nitrogen gas or a cooling liquid such as cooling water may be used. When the elastic wave detecting unit 42 is sufficiently heat-resistant, it is not necessary to provide the cooling mechanism 58.

In addition, here, a resilient member 62 such as a spring is installed at the rear side of the elastic wave detecting unit 42 so as to urge and bias the elastic wave detecting unit 42 against the attachment base end 50. The elastic member 62 is accommodated within a resilient member casing 64 which is integrated with the cooling casing 60. Thus, the adhesion of the end surface of the attachment base end 50 and the AE sensor 54 may be enhanced by the compressive force of the resilient member 62 so that the elastic wave may be efficiently propagated.

The elastic wave detecting unit 42 is connected to the determination unit 44 through a signal line 66 so that a detection result of the elastic wave detecting unit 42 may be transferred to the determination unit 44. In the middle of the signal line 66, an intensity filter unit 68, which is configured to output a signal which is not less than a predetermined intensity as an elastic wave detection signal, is interposed to cut a noise component. Here, the intensity filter unit 68 is configured to cut a signal having a gain which is not more than a predetermined level, for example, 40 dB as noise. As for the intensity filter unit 68, for example, a high speed AE measuring system, AMSY-6 (manufactured by Vallen Systeme GmbH), may be used.

In addition, the determination unit 44 is configured by, for example, a computer, and includes a count unit 70 configured to calculate the number of times of detecting the elastic wave detection signal, and a comparison unit 72 configured to compare the output of the count unit 70 and a predetermined reference value. The intensity filter unit 68 at the pre-stage outputs a needle end-shaped plus wave, which is generated when a film crack occurs, as an elastic wave detection signal S1. Thus, the count unit 70 is configured to measure the number of film crack occurrence times by counting the pulses of the needle end-shaped pulse wave.

In this case, as a first count aspect, the count unit 70 is configured to calculate an accumulation value after the most recent maintenance processing such as a cleaning processing has been performed for the processing container 4. That is, when the cleaning processing is performed, an unnecessary film attached to the inner wall surface of the processing container 4 is removed. Thus, the count unit 70 is configured to detect film cracks which have occurred after the cleaning processing and calculate an accumulation value obtained by adding and accumulating the number of detected film cracks. In addition, the count unit 70 is configured to output the accumulation value to the comparison unit 72. The count operation is performed not only during the film forming operation, but also during the warming of the processing container 4 which is performed just before the film forming processing and during the cooling of the processing container 4 which is performed after the film forming processing.

In the comparison unit 72, an empirically obtained threshold has been determined as a reference value in advance. Thus, the comparison unit 72 is configured to determine that “a maintenance processing is necessary to perform” when the accumulation value sent from the previous stage arrives at the reference value. In such a case, when the reference value for the accumulation value was set to, for example, about 100 and the film crack phenomenon has been detected 100 times, it is recognized that the maintenance processing is necessary.

In addition, the control of the overall of the film forming apparatus such as, for example, starting and stopping of gas supply, setting of a process temperature or process pressure, and controlling of the operation of the film crack detecting apparatus 40 are performed by an apparatus control unit 74. The apparatus control unit 74 includes a storage medium 76 such as, for example, a flexible disc, a compact disc (CD), a hard disc, a flash memory or a DVD that stores a computer-readable program for controlling the supply of various gases or the stop of the supply, ON/OFF controlling radio frequency, and controlling the overall of the apparatus.

Next, descriptions will be made on a case where the film forming method using the film forming apparatus 2 configured as described above forms a silicon nitride (SiN) film as an example. As illustrated in FIG. 1, the wafer boat 10 in which a plurality of (e.g., 50 to 150) wafers of a 300 mm size and of room temperature are arranged is lifted up from the underside of the processing chamber 4 and loaded into the processing container 4 of which the interior has been heated to a predetermined temperature in advance, and the lower end opening of the processing container 4 is closed by the closure 16, thereby sealing the interior of the processing container 4.

Then, the interior of the processing container 4 is evacuated and maintained at a predetermined process pressure, and the temperature of the processing container 4 and the temperature of the wafers W are elevated and maintained at the process temperature by increasing the power supply to the heating unit 38, and, for example, a silane-based gas and NH₃ gas are alternately and intermittently supplied from the plurality of supply systems 28, respectively. Thus, a silicon nitride film (SiN) is formed on the surfaces of the wafers W supported in the wafer boat 10 which is being rotated.

Then, when the film forming processing is ended, now in reverse, the supply of each gas is stopped and then the temperature of the processing container 4 and the temperature of the wafers W are reduced to a safety temperature, for example, in the range of about 300° C. to about 400° C. Then, when they become the safety temperature, processing-finished wafers W are unloaded by being lowered to the underside of the processing container 4, and then the processing-finished wafers W are discharged from the processing container 4. Here, during a series of operations as described above, the film crack detecting apparatus 40 according to the present disclosure is operated to perform the film crack detecting operation. That is, the film crack detection operation is performed during the warming of the processing container 4 prior to the film forming, during the film forming and during the cooling of the processing container 4 after the film forming.

As described above, when forming a thin film, an unnecessary film which becomes the cause of particles is deposited not only to the surfaces of the wafers W but also to all the surfaces of the structures within the processing container 4 such as the inner wall surface within the processing container 4, the surface of the gas nozzle 30, and the surface of the probe body 48 of the probe unit 41, and the unnecessary film is accumulated as the number of processed wafers increases. In addition, after a certain thickness, the unnecessary film cracks and becomes the cause of occurrence of particles. In particular, when the temperature of the processing container 4 is increased or reduced, the film cracks are more likely to occur due to heat shock.

Here, since the surface of the probe body 48 and the inner surface of the inner cylinder 4A are positioned within the same space to be in close vicinity to each other, unnecessary films will be adhered and deposited to the surfaces with the same condition and behavior for both of them. Accordingly, under the circumstance where film cracks occur in the film on the surface of the probe body 48, it is estimated that film cracks also occur in the film adhered to the inner surface of the inner cylinder 4A.

In addition, when a film crack occurs in the unnecessary film deposited to the surface of the rod-shaped probe body 48, an elastic wave is generated and transferred to the probe body 48 and the attachment base end 50. The elastic wave is detected by the elastic wave detecting unit 42 of the film crack detecting apparatus 40. The elastic wave detecting unit 42 is constituted by, for example, an AE sensor 54 including a piezoelectric element and a detection signal at the electric wave detecting unit 42 passes the intensity filter unit 68 through the signal line 56 and then is input to the determination unit 44. The intensity filter unit 68 allows only a signal having a predetermined intensity or more to pass therethrough in order to cut noise and outputs the signal as an elastic wave detection signal S1. Here, the intensity filter unit 68 is configured to allow only the signals of, for example, 40 dB or more to pass therethrough and to cut the signals of which the intensity is less than 40 dB.

In the determination unit 44, when one sharp needle end-shaped elastic wave detection signal S1 is input, the count unit 70 counts “1,” adds up such a count value to obtain an accumulation value after a maintenance processing, for example, a cleaning processing, and then sends the accumulation value to the comparison unit 72 of the post-stage. Meanwhile, the accumulation value of the count unit 70 is reset at every maintenance processing of the processing container 4, for example, at every cleaning processing.

In addition, the comparison unit 72 compares the accumulation value input from the count unit 70 with the reference value set in advance for the accumulation value, for example, “100.” When the accumulation value input from the count unit 70 of the previous stage is not less than the reference value, the comparison unit 72 determines that “a maintenance processing is necessary.” Further, the result is displayed on the display unit 45 to call the attention of an operator. Meanwhile, the reference value “100” is merely an example and the reference value is not limited thereto. In such a case, even if it is determined that “a maintenance processing is necessary,” the warming operation and the film-forming processing are not instantly stopped and the film forming processing is complete for the wafers that are presently under processing. In addition, a maintenance processing of the processing container 4, for example, a cleaning processing is performed prior to performing the next film forming processing.

As described above, since film cracks of an unnecessary film deposited to the surface of the probe unit are detected during the warming of the semiconductor wafers W, during the film forming processing and during the cooling of semiconductor wafers W, the possibility of occurrence of particles may be recognized in real time. Thus, when film cracks occur in the film on the surface of the probe unit, it may be estimated that the film adhered to the inner surface of the inner cylinder 4A installed under the same environment is also in the situation in which film cracks occur likewise.

As described above, according to the present disclosure, a film crack detecting apparatus 40 provided in a film forming apparatus, which includes a processing container 4 which accommodates an object to be processed, for example, a semiconductor wafer W, and forms a thin film on the surface of the object to be processed, to perform a film crack detection operation. In addition, the film crack detecting apparatus 40 provided in the film forming apparatus to perform a film crack detection operation is configured to include a probe unit 41 provided in the processing container 4, an elastic wave detecting unit 42 attached to an end of the probe unit 41 to detect an elastic wave, and a determination unit 44 configured to determine whether a maintenance of the processing container 4 is necessary based on a detection result of the elastic wave detecting unit 42. Thus, the possibility of occurrence of particles may be recognized in real time by estimating the film cracks of an unnecessary film adhered to, for example, the inner wall of the processing container by detecting the film cracks occurring in the film adhered to the surface of the probe unit 41. Accordingly, a maintenance processing such as a cleaning processing may be properly performed in a timely manner.

<Modified Example of Count Aspect>

Next, descriptions will be made on a modified example of the count aspect for the number of film crack occurrence times in the count unit 70. The first count aspect described above obtains an accumulation value by adding up the number of film crack occurrence times after the most recent maintenance processing, for example, a cleaning processing. However, the count aspect is not limited thereto and may be conducted as follows.

First, as a second count aspect, the count unit 70 may be configured to calculate an accumulation value of every unit time which is intermittently measured. Specifically, the count unit 70 may be configured to perform the film crack detection operation for a predetermined unit time, for example, only for 1 sec, for example, whenever pausing for one minute, rather than continuously performing the film crack detection operation, and to repeatedly perform the operation. In addition, the number of film cracks detected through the film crack detection operation for 1 sec is added and accumulated. That is, the film crack detection operation may be performed only for 1 sec at one minute intervals.

In this case, the reference value which is the threshold in the comparison unit 72 becomes an accumulation value for intermittent periods and is set to a value (e.g., 10) which is smaller than the reference value for the previous accumulation value (e.g., 100). In this case, acting effects equivalent to those of the first count aspect may also be exhibited.

Next, as the third count aspect, the count unit 70 may be configured to calculate the number of times of detecting an elastic wave detection signal at every unit time. Here, for example, the film crack detection operation is performed continuously, the number of detected film cracks at every unit time, for example, at every 1 sec, and the count value of every 1 sec is output. In this case, the reference value which is the threshold in the comparison unit 72 becomes a count value for unit time and is set to a value (e.g., 2) which is smaller than the reference value of the second count aspect (e.g., 5). In this case, acting effects equivalent to those of the previous first count aspect may be exhibited.

Next, as the fourth count aspect, the count unit 70 is configured to calculate the number of times of detecting an elastic wave detection signal at every unit time and to calculate the increase tendency of the number of detection times of every unit time. For example, the number of times of occurrence of a film crack phenomenon sharply increases quadrically when it is near the time when a maintenance processing is required. Thus, the count unit 70 is configured to catch this sharp increase. Specifically, for example, the count unit 70 continuously performs the film crack detection operation, counts the number of detected film cracks at every unit time, for example, at every 60 sec, and calculates the count value of every 60 sec. In addition, the comparison unit compares the count value with the count value of every 60 sec just before the current 60 sec, and calculates and outputs the increasing rate. For example, when the count value for 60 sec just before the current 60 sec is 5 and the count value for the current 60 sec is 10, the increasing rate is 100% which is output.

The reference value which is the threshold in the comparison unit 72 becomes the reference value for increasing rate and is set to, for example, “100%.” That is, when the increasing rate of crack occurrence becomes 100% or more, it is determined that “a maintenance processing is necessary”. Here, the unit time, 60 sec, and the reference value, 100%, are merely examples and are not limited thereto. In this case, acting effects equivalent to those of the previous first count aspect may be exhibited.

### First Modified Embodiment

Next, a first modified embodiment of the film crack detecting apparatus of the present disclosure will be described. In the previous exemplary embodiment, the intensity filter unit 68 is provided between the elastic wave detecting unit 42 and the determination unit 44 so as to cut noise. However, in order to cut noise more certainly, a first frequency filter unit which narrows a frequency range may be additionally provided. FIG. 4 is a view illustrating a portion of the first modified embodiment of the film crack detecting apparatus of the present disclosure. The components which are the same as those illustrated in FIGS. 1 to 3 will be assigned with the same reference symbols and the descriptions thereof will be omitted.

As illustrated in FIG. 4, in the present modified embodiment, a first frequency filter unit 78 is provided in the signal line 66 between the intensity filter unit 68 and the determination unit 44, in which the first frequency filter unit 78 is configured to cut a signal in a predetermined frequency range among the signals output from the intensity filter unit 68. As for the first frequency filter unit 78, a band pass filter may be used. A band pass filter configured to cut a frequency lower than, for example, 200 kHz and a frequency higher than, for example, 400 kHz and to allow only a signal in the frequency range of 200 kHz to 400 kHz to pass therethrough is used as the band pass filter. As described below, a sharp needle end-shaped signal is included in an elastic wave generated when a film crack is generated, in particular at the frequency of about 300 kHz. Thus, it becomes possible to further enhance the detection precision by detecting the sharp needle end-shaped signal.

<Verification Test of Film Crack Occurrence>

Verification tests were actually performed using the film crack detecting apparatus 40 illustrated in FIGS. 1 to 3. Thus, the evaluation results will be described. Here, two quartz tubes of which the outer diameter is 15 mm, the inner diameter is 12 mm and the length 1,400 mm were prepared, and one of the quartz tubes was coated with a silicon nitride film (SiN film) over the entirety of the inner and outer surfaces thereof with a sufficient thickness (3 μm). The other quartz was used as it is without coating any film.

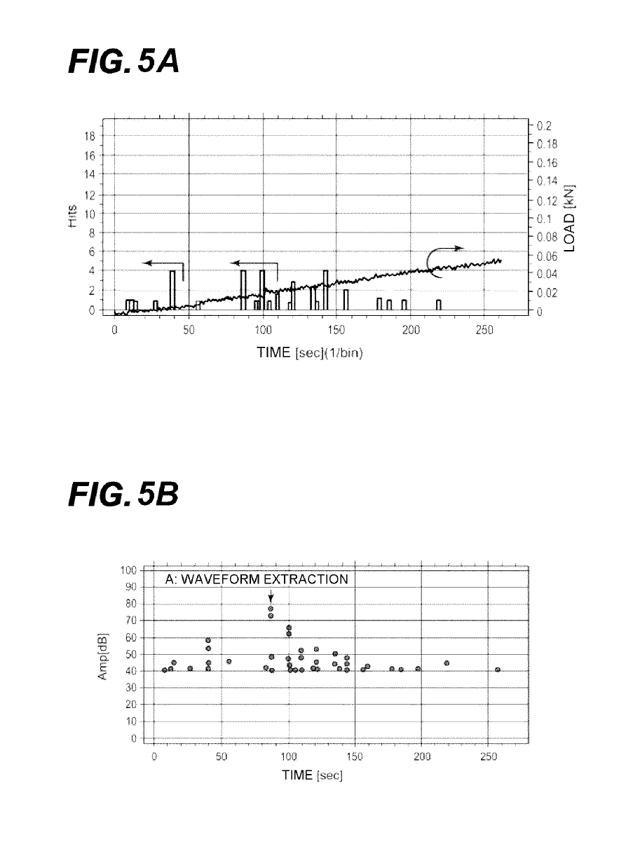

In a state where the opposite ends of the quartz tubes were horizontally supported and fixed, a load was gradually applied to the central portions thereof in the vertical direction and elastic waves generated at that time were detected by an AE sensor. FIGS. 5A and 5B are graphs representing the relationship between the loads and film cracks in which FIG. 5A represents the relationship between the loads applied to the quartz tubes and the number of occurring film cracks (Hits: the number of hits). In FIG. 5A, the horizontal axis indicates time, the right vertical axis indicates load, and the left vertical axis indicates the number of occurring film cracks (Hits). In FIG. 5B, the horizontal axis indicates time and the vertical axis indicates signal intensity (Amp). Here, a signal of 40 dB or less is cut by the filter (corresponding to the intensity filter unit 68 of FIG. 1) to prevent the infiltration of noise.

First, a load was applied to the two quartz tubes for about 260 sec in such a manner that the load is linearly increased from 0 kN to 0.05 kN. In the case of the filmless quartz tube which was not coated with a silicon nitride film, no hit existed in relation to the film crack occurrence until the quartz tube was fractured, and the number of hits was “zero.”

In comparison, in the case of the film adhered quartz tube which was coated with the silicon nitride film, as illustrated in FIG. 5A, film cracks start to occur when the load is in the vicinity about 0.01 kN and as the load increases, film cracks occur sporadically. The number of occurring film cracks is counted up to 4 in the vicinity of each of 40 sec, 85 sec, 100 sec and 140 sec.

FIG. 5B illustrates the intensities of elastic waves (dB) when the occurrence of film cracks in FIG. 5A was detected, in which each point in the graph indicates the occurrence of a film crack. According to the graph, it can be seen that the intensity of the elastic wave on the horizontal axis is the largest when the time is at 90 sec (in the vicinity of 0.15 kN). From these graphs, it may be appreciated that the occurrence of film cracks may be caught by detecting the elastic waves.

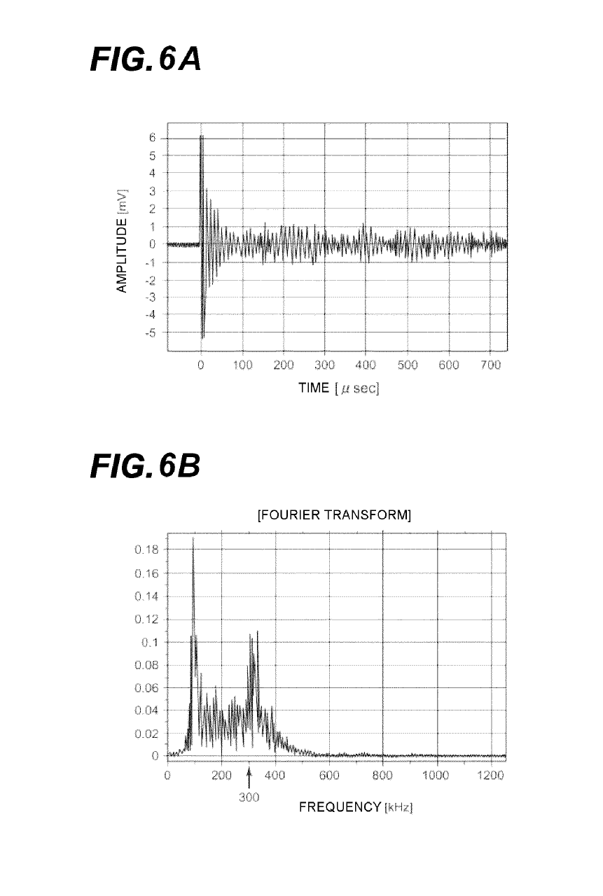

Next, analysis was made by extracting the waveform of the elastic wave of point A where the signal intensity of the elastic wave was the largest in FIG. 5B. The result is illustrated in FIGS. 6A and 6B. FIGS. 6A and 6B show waveforms at the point where the intensity of the elastic wave was the largest, in which FIG. 6A illustrates amplitude and FIG. 6B illustrates frequency distribution which was obtained through the Fourier transform of the signal of FIG. 6A. As illustrated in FIG. 6A, it can be seen that, in the detected wave, a very sharp needle end-shaped signal of a large amplitude appears in a width of several μsec and then a waveform of a weak amplitude is continued for about 700 μsec.

Upon analyzing the frequencies of the waveforms at this time, sharp peak waveforms appear in the vicinity of 100 kHz and 300 kHz. Although not illustrated, these two peak waveforms also appear similarly in the detection signals of other elastic waves. Accordingly, in order to more certainly prevent the mixing of noise, it may be appreciated that the low-frequency peak waveform of about 100 kHz may be cut and the high-frequency peak waveform of about 300 kHz may be detected. For this reason, the first modified embodiment illustrated in FIG. 4 is configured such that a peak waveform centering on 300 kHz is detected using the first frequency filter unit 78 configured to allow only a signal within the range of 200 kHz to 400 kHz to pass therethrough.

### Second Modified Embodiment

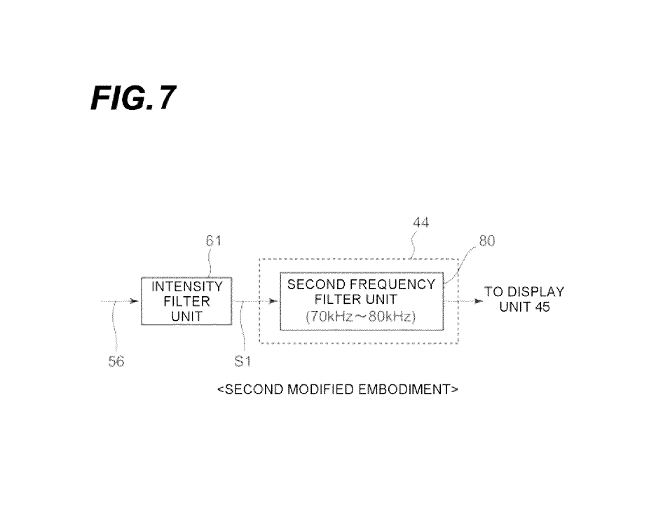

Next, the second modified embodiment of the film crack detecting apparatus of the present disclosure will be described. In the previous exemplary embodiment, the determination unit 44 is configured to include the count unit 70 and the comparison unit 72. Instead, a second frequency filter unit configured to determine whether an output of the intensity filter unit 68 has a signal of a specific frequency range may be used. FIG. 7 is a block diagram illustrating a portion of the second modified embodiment of the film crack detecting apparatus of the present disclosure. In FIG. 7, the components which are the same as those illustrated in FIGS. 1 to 6 will be assigned with the same reference symbols, and the descriptions thereof will be omitted.

Here, only the second frequency filter unit 80 configured to allow a signal of a specific frequency range to pass therethrough is provided as the determination unit 44. As for the second frequency filter unit 80, a band pass filter configured to allow the signal of frequency range of, for example, 70 kHz to 80 kHz to pass therethrough and to cut other frequencies may be used. The signal of the frequency range of 70 kHz to 80 kHz is an elastic wave generated when a micro-crack occurs in the surface of the probe unit 41, the surface of the processing container 4 made of quartz or the surface of a quartz tube. It has been known that when such a micro-crack occurs, a film crack also occurs inevitably in the unnecessary film deposited to those surfaces. Accordingly, when the micro-crack occurs in the surface of the quartz tube, it is determined that “a maintenance processing is necessary” by estimating that a lot of film cracks occur in the unnecessary film.

The second modified embodiment may be used in substitution for the exemplary embodiment illustrated in FIGS. 1 to 6, or in parallel to the exemplary embodiment by branching the signal line 66 in the middle of the signal line 66.

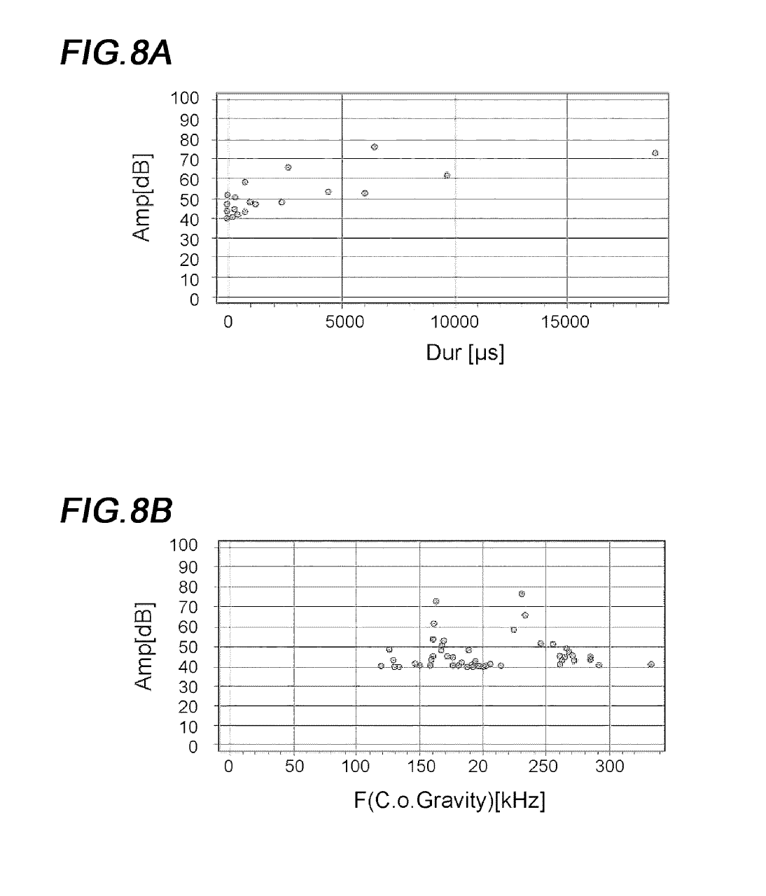

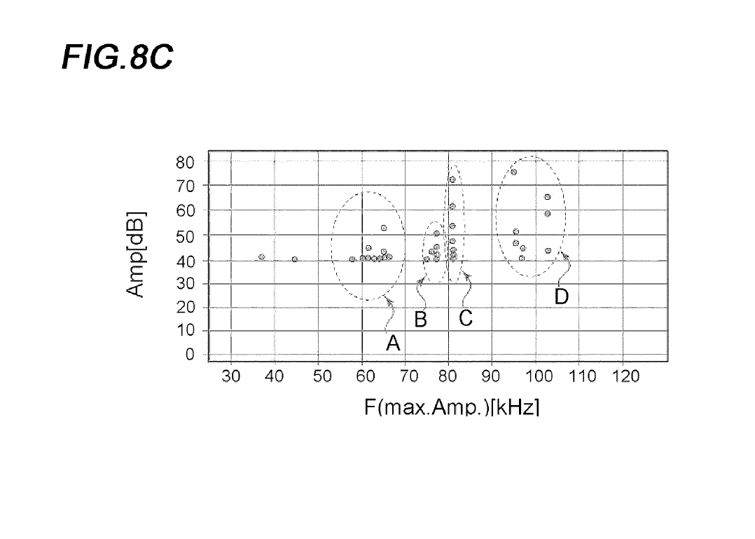

A signal analysis was performed for elastic wave signals when micro-cracks occur. Thus, the analysis results will be described here. FIGS. 8A to 8C are graphs for analyzing the occurrence of micro-cracks obtained based on the data of FIGS. 5A and 5B, in which FIG. 8A is a graph illustrating the relationship between the maximum amplitudes (Amp) and waveform duration times (Dur), FIG. 8B is a graph illustrating the relationship between the maximum amplitudes and the central frequencies, and FIG. 8C is a graph illustrating the relationship between the maximum amplitudes and peak frequencies (F).

Here, the “waveform duration time” refers to a length of time for which a parabola of an AE waveform (elastic wave) is maintained at a predetermined value or more. In addition, the central frequency is a central position of an integral value of an equation obtained at the frequency analysis and is calculated by the following equation.

Central frequency(kHz)=ΣEi·Fi/ΣEi

Here, Ei is a magnitude of a frequency component, and Fi is frequency.

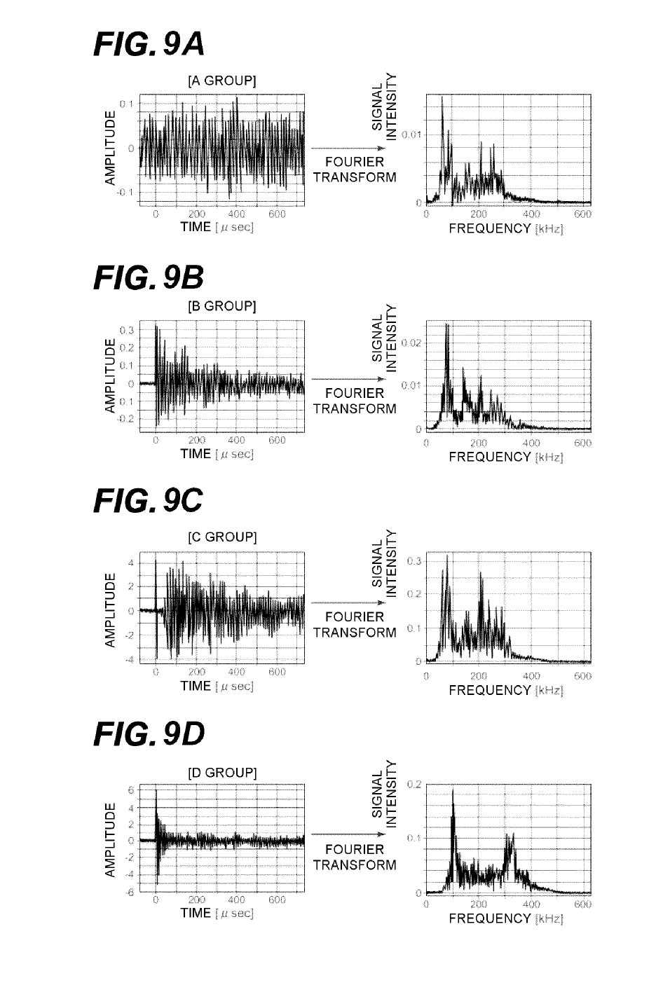

From the interrelations illustrated in FIGS. 8A and 8B, it has been confirmed that they are classified into four groups of A to D as illustrated in FIG. 8C. Specifically, elastic waves which were detected AE original waves were analyzed in connection with the magnitudes of amplitudes, waveform duration times, and frequencies as illustrated in FIGS. 6A and 6B and classified into the groups. FIGS. 9A to 9D are graphs illustrating the relationships between the AE original waves and frequency distributions of the groups, respectively. FIG. 9A illustrates group A, FIG. 9B illustrates group B, FIG. 9C illustrates group C, and FIG. 9D illustrates group D. In each of the graphs of the left column, the horizontal axis indicates time, and the vertical axis indicates amplitude. In each of the graphs of the left column, the horizontal axis indicates frequency and the vertical axis indicates signal intensity after Fourier transform.

When observing the waveforms of the AE original waves (elastic waves) belonging to the groups, it was confirmed that the features of waveforms are different from each other as illustrated in FIGS. 9A to 9D. It is believed that the waveforms become different from each other due to the different occurrence mechanisms of the AE original waves which are classified into groups A to D as follows based on the occurrence frequencies and timing.

Group A: occurrence and progress of micro-cracks in SiN film

Group B: occurrence and progress of micro-cracks in quartz glass

Group C: unknown phenomenon

Group D: unknown phenomenon

Here, through the elastic waves belonging to group B in FIG. 8C, it was confirmed that micro-cracks occurred on the quartz surface and film cracks occurred due to the cracks in the quartz surface. Accordingly, it can be seen that micro-cracks occurring on the quartz surface and the occurrence of film cracks caused due to the cracks of the quartz surface may be detected by detecting the elastic waves in the frequency range where group B belongs, i.e. in the frequency range of 70 kHz to 80 kHz as described above with reference to FIG. 7.

### Third Modified Embodiment

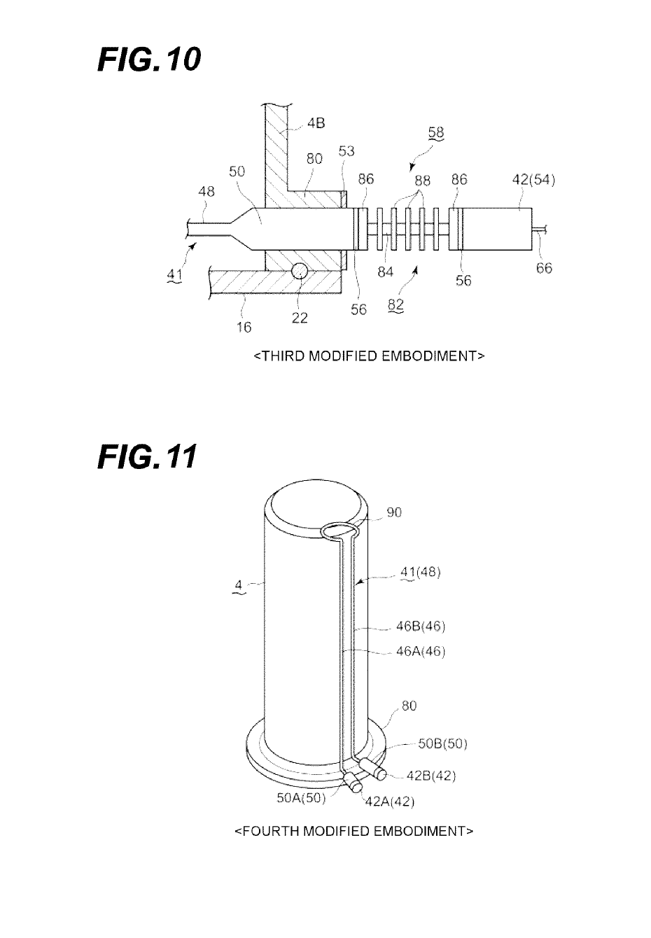

Next, the third modified embodiment of the film crack detecting apparatus of the present disclosure will be described. In the previous exemplary embodiment, a cooling mechanism using a cooling medium is used as for the cooling mechanism 58. However, a cooling mechanism using heat-dissipation fins may be used instead or in addition to. FIG. 10 is a block diagram illustrating a portion of a third modified embodiment of the film crack detecting apparatus of the present disclosure. In FIG. 10, the components which are the same as those illustrated in FIGS. 1 to 9 will be assigned with the same reference symbols and descriptions thereof will be omitted.

Here, as for the cooling mechanism 58, a wave guide rod member equipped with heat-dissipation fins is used. The wave guide rod member 82 of the cooling mechanism 58 is entirely formed of a metal such as, for example, aluminum or stainless steel. However, as for the wave guide rod member 82, a member formed from quartz or a member formed of a ceramic material may be used without being limited to those formed of a metal. Specifically, the wave guide rod member 82 includes a rod body 84 configured to facilitate transfer of an elastic wave and having a length of several cm and is provided with a disc-shaped attachment plate 86 at each end of the rod body 84. Further, a plurality of heat-dissipation fins 88 are arranged at a predetermined interval and attached to the rod body 84 and configured to be capable of cooling the rod body 84 to a temperature which is not higher than the heat resistance temperature of the AE sensor 54 of the elastic wave detecting unit 42.

In addition, the wave guide rod member 82 is interposed between the attachment base end 50 of the probe unit 41 and the elastic wave detecting unit 42. Contact mediums 56 are interposed between the end surface of the attachment base end 50 and the attachment plate 86 at the front end and between the elastic wave detecting unit 42 and the attachment plate 86, respectively, so that elastic waves may be efficiently transferred. In the illustrated example, a resilient member 62 such as a spring that elastically biases the elastic wave detecting unit 42 is not illustrated. However, the resilient member may also be proved in this modified embodiment. The third modified embodiment may exhibit the same acting effects as those of the first and second modified embodiments.

### Fourth Modified Embodiment

Next, the fourth modified embodiment of the film crack detecting apparatus of the present disclosure will be described. In the previous exemplary embodiment, it is not possible to specify a film crack occurrence position in the probe body 48. However, in the fourth modified embodiment, the probe body 48 is provided to reciprocate in the vertical direction and two elastic wave detecting units are proved at the opposite ends of the probe body 48 so that the probe body 48 may specify a film crack occurrence position.

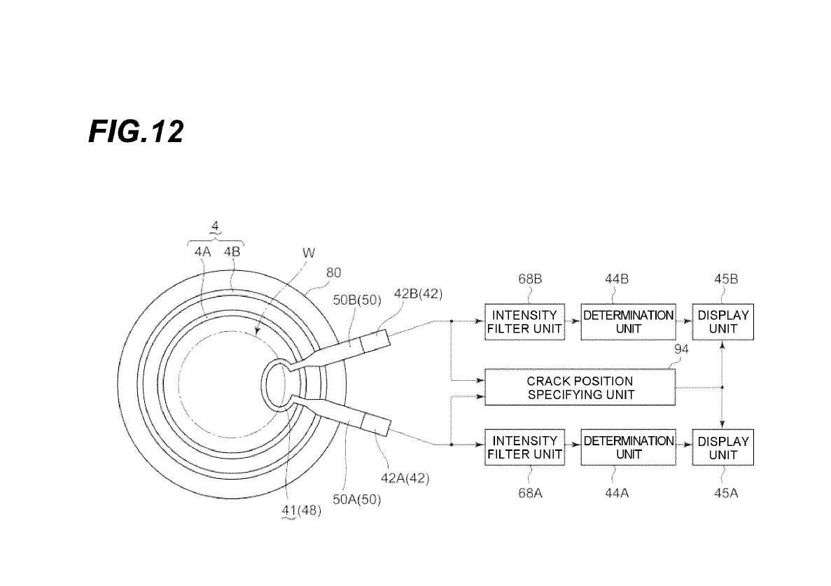

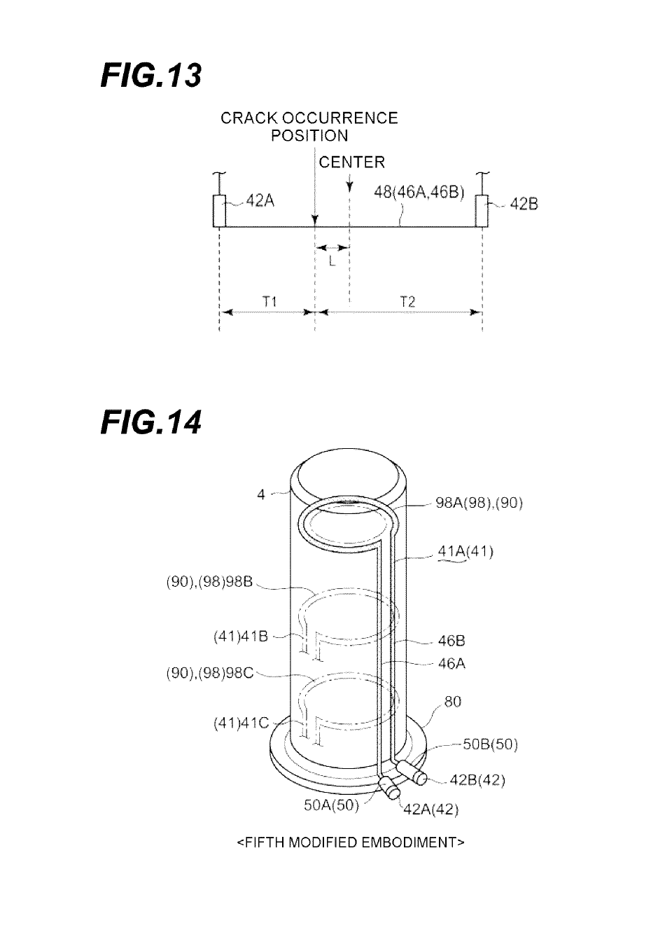

FIG. 11 is a schematic view illustrating a principal portion of the fourth modified embodiment of the film crack detecting apparatus of the present disclosure, FIG. 12 is a block diagram illustrating the configuration of the fourth modified embodiment, and FIG. 13 is a view for describing the principle of specifying a film crack occurrence position. In FIGS. 11 to 13, the components which are the same as those illustrated in FIGS. 1 to 10 will be assigned with the same reference symbols and the descriptions thereof will be omitted.

As illustrated in FIG. 11, in the fourth modified embodiment, the probe body 48 of the probe unit 41 includes two vertical probe portions 46A, 46B which extend upwardly in the inner cylinder 4A of the processing container 4 along the height direction of the processing container 4 to be parallel to each other and the top ends of the vertical probe portions 46A, 46B are connected with each other by, for example, a connection portion 90 formed in a circular arc shape. That is, the two vertical probe portions 46A, 46B and the connection portion 90 are entirely formed by one member. For example, the vertical portions 46A, 46B and the connection portion 90 may be shaped by flexurally deforming a rod-shaped quartz member to be turned round at the longitudinal central portion thereof.

Both the lower ends of the two vertical probe portions 46A, 46B are bent substantially at a right angle, provided with the attachment base ends 50A, 50B, respectively, and supported and fixed to the lower end of the processing container 4. In addition, as illustrated in FIG. 12, elastic wave detecting units 42A, 42B are provided at the end surface sides of the attachment base ends 50A, 50B, respectively, which are positioned at the ends of the vertical probe portions 46A, 46B, respectively. Further, 42B, intensity filter units 68A, 68B, determination units 44A, 44B, and display units 45A, 45B are provided at the rear end sides of the elastic wave detecting units 42A, respectively, so that the occurrence of a film crack may be detected.

To each of the above-described components of this modified embodiment, the previous first to third modified embodiments may be applied. In addition, each of the intensity filter units 68A, 68B, the determination units 44A, 44B and the display units 45A, 45B may be commonly used. In addition, in the fourth modified embodiment, a film crack position specifying unit is provided which is configured to specify a film crack occurrence position based on the detection results of the two elastic wave detecting units 42A, 42B. The film crack specifying unit 94 recognizes the probe body 48 having the two vertical probe portions 46A, 46B and the connection portion 90 as one member and specifies where in the longitudinal direction of the probe body 48, a film crack has occurred.

Specifically, as illustrated in FIG. 13, the elastic wave detecting units 42A, 42B are provided at the opposite ends of the probe body 48 (46A, 46B), respectively, and it is assumed that a film crack occurred at a position of a distance L from the longitudinal center of the probe body 48. It is also assumed that an elastic wave is detected by one elastic wave detecting unit 42A after T1 sec after the film crack occurred, and the elastic wave is detected by the other elastic wave detecting unit 42B after T2 after the film crack occurred. As such, the distance L may be calculated by the following equation.

L=[(T1−T2)×C]/2

C: transfer speed of the elastic wave transferred through the probe body.

T1−T2: time difference

As described above, the fourth modified embodiment may exhibit the same acting effect as those of the previous first to third modified embodiments. Furthermore, the fourth modified embodiment may specify where a film crack occurred in the height direction within the processing container 4 by calculating the distance L. By specifying the occurrence of a film crack in this manner, the fourth modified embodiment may contribute to the optimization of employment of, for example, a process processing.

### Fifth Modified Embodiment

Next, the fifth modified embodiment of the film crack detecting apparatus of the present disclosure will be described. In the previous fourth modified embodiment, although the film crack occurrence position in the height direction of the probe body 48 may be specified, the film crack occurrence position in the circumferential direction of the processing container 4 cannot be specified. The fifth modified embodiment enables the film crack occurrence position to be specified not only in the height direction of the probe body 48 but also in the circumferential direction of the probe body 48. FIG. 14 illustrates a configuration of a principal portion of the fifth modified embodiment of the film crack detecting apparatus of the present disclosure. In FIG. 14, the components which are the same as those illustrated in FIGS. 1 to 13 are assigned with the same reference symbols and the descriptions thereof will be omitted.

As illustrated in FIG. 14, in the fifth modified embodiment, a ring-shaped horizontal probe portion 98 is provided as a connecting portion 90 in the probe unit 41 having, for example, two vertical probe portions 46A, 46B as illustrated in FIG. 11. The ring-shaped horizontal probe portion 98 extends in the circumferential direction of the processing container 4 over almost all the entire circumference of the processing container 4. That is, the top ends of the two vertical probe portions 46A, 46B are connected by the ring-shaped horizontal probe portion 98. The ring-shaped horizontal probe portion 98 is also formed in a shape which is the same as the connecting portion 90 as illustrated in FIG. 11 described above using, for example, a rod-shaped quartz member.

Thus, the ring-shaped horizontal probe portion 98 is configured to be disposed along the outer circumferential side of semiconductor wafers W. In addition, a plurality of (e.g., three) such probe units 41 are provided, which are illustrated as probe units 41A, 41B, 41C. Further, the ring-shaped horizontal probe units 98A, 98B, 98C of the probe unit 41A, 41B, 41C are disposed such that the height positions thereof are to be different from each other. Here, the height direction of the processing container 4 is classified into three zones, i.e. a top zone, a middle zone and a bottom zone and the three ring-shaped horizontal probe units 98A, 98B, 98C are provided to correspond to the top zone, the middle zone and the bottom zone, respectively.

In addition, as described in the fourth modified embodiment, each of the probe units 41A, 41B, 41C is provided with, for example, two elastic wave detecting units 42 to be capable of detecting film crack occurrence and specifying the film crack occurrence position.

The fifth modified embodiment may not only exhibit the same acting effects as those of the first to fourth modified embodiments but also specify the film crack occurrence position in the circumferential direction in the processing container 4. Although three probe units 41A, 41B, 41C are provided in the fifth modified embodiment but are not limited thereto. The present disclosure may provide more probe units or provide one or two probe units among the three probe units.

Meanwhile, in each of the above-described embodiments, it has been exemplified that heat-resistant quartz is used as a material for configuring the processing container 4 and the probe unit 41. However, the present disclosure is not limited thereto, and, for example, SiC (silicon carbide) and polysilicon may be used. In addition, a dual tube structure is used as for the processing container 4 herein. However, the present disclosure is not limited thereto and may also be applied to a processing container of a single tube structure.

In addition, although it has been exemplified in the above-described exemplary embodiments that a silicon nitride film is formed as a thin film, the present disclosure is not limited thereto and may applied to a case where any other thin film is formed. Further, although it has been exemplified herein that an object to be processed is a semiconductor wafer, the semiconductor may include a silicon wafer, or a compound semiconductor of, for example, GaAs, SiC, GaN. Moreover, the present disclosure is not limited to these substrates but may also be applied to, for example, a glass substrate used in a liquid crystal display device or a ceramic substrate.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A film crack detecting apparatus provided in a thin film forming apparatus which includes a processing container configured to accommodate an object to be processed and forms a thin film on a surface of the object, the film crack detecting apparatus comprising:
a probe unit provided within the processing container;
an elastic wave detecting unit attached to an end of the probe unit and configured to detect an elastic wave; and
a determination unit configured to determine whether a maintenance of the processing container is necessary based on a detection result of the elastic wave detecting unit.

2. The film crack detecting apparatus of claim 1, wherein the probe unit is provided along a height direction of the processing container.

3. The film crack detecting apparatus of claim 1, wherein the probe unit includes a probe body which is provided with a vertical probe portion having a lower end fixed to a lower end of the processing container and extending along a height direction of the processing container.

4. The film crack detecting apparatus of claim 2, wherein the probe body is provided with two vertical probe portions each having a lower end fixed to a lower end of the processing container and extending upwardly along the height direction of the processing container in parallel to each other, the vertical probe portions being connected with each other at top ends thereof.

5. The film crack detecting apparatus of claim 4, wherein the elastic wave detecting unit is provided at each end side of the vertical probe portions, and the film crack detecting apparatus further comprises a film crack position specifying unit configured to specify a film crack occurrence position based on a detection result of the elastic wave detecting unit.

6. The film crack detecting apparatus of claim 3, wherein the probe body includes:
two vertical probe portions each having a lower end fixed to a lower end of the processing container and extending upwardly along the height direction of the processing container in parallel to each other, and
a ring-shaped horizontal probe portion extending substantially all around the processing container in the circumferential direction of the processing container and formed by connecting top ends of the two vertical probe portion.

7. The film crack detecting apparatus of claim 6, wherein a plurality of probe units are provided and the ring-shaped horizontal probe portions of the probe units are disposed at different height positions.

8. The film crack detecting apparatus of claim 6, wherein the elastic wave detecting unit is provided at each end side of the vertical probe portions, and the film crack detecting apparatus further comprises a film crack position specifying unit configured to specify a film crack occurrence position based on a result of the elastic wave detecting unit.

9. The film crack detecting apparatus of claim 1, wherein the probe unit is formed in a hollow rod shape or a solid rod shape.

10. The film crack detecting apparatus of claim 1, wherein the probe unit is formed of a material which is the same as that of the processing container.

11. The film crack detecting apparatus of claim 1, wherein the processing container is formed in a double tube structure of an inner cylinder and an outer cylinder and the probe unit is positioned inside of the inner cylinder.

12. The film crack detecting apparatus of claim 1, wherein the elastic wave detecting unit outputs a plurality of signals and the film crack detecting apparatus further comprises an intensity filter unit configured to output a signal having an intensity of a predetermined level or more among the signals output from the elastic wave detecting unit as an elastic wave detection signal.

13. The film crack detecting apparatus of claim 12, further comprising a first frequency filter unit configured to allow a signal of a predetermined frequency range among the signals output from the intensity filter unit to pass through the first frequency filter.

14. The film crack detecting apparatus of claim 12, wherein the determination unit includes:
a count unit configured to calculate the number of times of detecting elastic wave detection signals, and
a comparison unit configured to compare the output of the count unit with a reference value set in advance.

15. The film crack detecting apparatus of claim 14, wherein the count unit calculates an accumulation value after a most recent maintenance processing has been performed for the processing container.

16. The film crack detecting apparatus of claim 14, wherein the count unit calculates an accumulation value of every unit time which is intermittently measured.

17. The film crack detecting apparatus of claim 14, wherein the count unit calculates the number of times of detecting the elastic wave detection signal at every unit time.

18. The film crack detecting apparatus of claim 14, wherein the count unit calculates the number of times of detecting the elastic wave detection signal and calculates an increase tendency of the number of detection times at every unit time.

19. The film crack detecting apparatus of claim 12, wherein the determination unit includes a second frequency filter unit configured to determine whether the output of the intensity filter unit has a signal of a predetermined frequency range.

20. The film crack detecting apparatus of claim 1, wherein film crack detection is performed during the warming of the processing container, during the cooling of the processing container, and during the forming of the thin film.

21. The film crack detecting apparatus of claim 1, further comprising a display unit configured to display a determination result of the determination unit.

22. The film crack detecting apparatus of claim 1, wherein the elastic wave detecting unit is provided with a cooling mechanism configured to cool the elastic wave detecting unit.

23. The film crack detecting apparatus of claim 1, wherein a wave guide rod member is interposed between the probe unit and the elastic wave detecting unit.

24. The film crack detecting apparatus of claim 23, wherein the wave guide rod member is formed with a heat-dissipation fin.

25. A film forming apparatus comprising:
a processing container configured to accommodate an object to be processed;
a holding unit configured to hold the object;
a heating unit configured to heat the object;
a gas supply unit configured to supply a gas into the processing container so that a thin film is formed on a surface of the object;
an exhaust system configured to exhaust the atmosphere within the processing container,
a film crack detecting apparatus defined in claim 1; and
an apparatus control unit configured to control an overall operation of the film forming apparatus.
